(19) United States
(12) Patent Application Publication
(10) Pub. No.: US 2022/0020285 A1
(43) Pub. Date: Jan. 20, 2022

(54) A MOVEMENT SIMULATOR

(71) Applicant: E2M TECHNOLOGIES B.V., Amsterdam (NL)

(72) Inventors: Pieter LOOKEREN CAMPAGNE, Amsterdam (NL); Martijn BRUIJNS, Amsterdam (NL)

(73) Assignee: E2M TECHNOLOGIES B.V., Amsterdam (NL)

(21) Appl. No.: 17/299,829

(22) PCT Filed: Dec. 5, 2019
(86) PCT No.: PCT/EP2019/083894

§ 371 Date: Jun. 4, 2021

(30) Foreign Application Priority Data
Dec. 7, 2018 (NL) 2022155

(51) Int. Cl. G09B 9/12; G09B 9/46

(52) U.S. Cl. CPC G09B 9/12; G09B 9/46

(57) ABSTRACT

The invention is directed to a movement simulator (1) comprising of a moveable support (2) having three translational degrees of freedom connected to a base (3) by means of three actuators (4), wherein each actuator (4) comprises a rotating shaft (5) having two outer ends (6,7) and comprising two spaced apart cranks (10,11), an electric motor (21) comprising a rotor (22) and a stator (23), a support structure (8,9) comprising bearings (26,27) for the rotating shaft (5). The support structure is connected to the base (3), a pair of links (12,13) connecting the cranks (10,11) of shaft (5) to the moveable support (2). One crank (10) is positioned at one outer end (6) of the shaft (5) and the other crank (11) is positioned at the opposite outer end (7) of the shaft (5). Part of the rotating shaft (5) is the rotor (22) of the electric motor (21).

The invention is directed to a movement simulator having three translational degrees of freedom comprising of a moveable support having three degrees of freedom connected to a base by means of three actuators, wherein each actuator comprises a rotating shaft, an electric motor, a support structure comprising bearings for the rotating shaft and two links. Each link is connected to a crank on the rotating shaft at one side of the link and to the moveable support at the opposite end of the link. The support is connected to the base.

A prior art movement simulator having three translational degrees of freedom is described in WO2013/050626. This publication describes a vibration simulator suitable for a helicopter simulator. Three actuators are connected to a platform. The actuators have a rotating shaft provided with two spaced apart cranks. Push pull rods connect the cranks to the platform. The rotating shaft is connected to a base by two supports, each comprising a bearing for the rotating shaft. The two supports are positioned at the two outer ends of the shaft. This construction enables three translational degrees of freedom and no rotational degrees of freedom along the yaw axis, transverse axis or longitudinal axis. The rotating shaft is driven by an electric motor. The electric motor is connected to the shaft via a push pull rod. This push pull rod is connected to an excenter on the rotating shaft of the electric motor and to a driving crank positioned half way the rotating shaft. Normally, the oscillating rotation of the rotor of the electric motor will result in an oscillating movement of the shaft. In case of a control failure resulting in—for instance—a continuous rotation of the motor shaft, the rotating shaft will still oscillate, and the system will be safe. Given a situation that the central crank and the two spaced apart cranks have an identical radius, the maximum translational actuator movement via the push pull rods is defined by the excenter radius on the motor shaft. An excenter radius of 10 mm, resulting in a stroke of maximum 20 mm, may be used for a typical helicopter simulator.

WO2013/050626 further states that the rotating shaft may be driven directly. Such a directly driven shaft for a movement simulator having three translational degrees of freedom is for example shown in Youtube video titled “Kollmorgen Cartridge DDR Motor used in Earthquake simulator built by ANCO Engineers” (https://www.youtube.com/watch?v=JFILA_yo6Bs). This video shows how the shaft is rotated by an electric motor drives one end of the shaft positioned exterior relative to the two cranks present on the shaft.

U.S. Pat. No. 6,077,078 described a movement simulator enabling a movement platform to be moved along pitch, roll and vertical displacement. The moving platform is connected at three points to a separate actuator via a double cardan joints. The double cardan joints are connected to the actuator via two arms which extend from the a crank at the two ends of a rotating shaft. The rotating shaft is driven by an electric motor consisting of two output shafts driving two gear boxes. two gear boxes.

A disadvantage of the movement simulator described in WO2013/050626 and in the above described YouTube video is that a shaft is required having a relatively large torsion rigidity.

The present invention aims at providing a movement simulator which does not have such a disadvantage.

This is achieved by the following movement simulator. A movement simulator comprising of a moveable support having three translational degrees of freedom connected to a base by means of three actuators, wherein each actuator comprises

a rotating shaft having two outer ends and comprising two spaced apart cranks, an electric motor comprising a rotor and a stator, a support structure comprising bearings for the rotating shaft, which support structure is connected to the base and a pair of links connecting the cranks of shaft to the moveable support,

wherein one crank is positioned at one outer end of the shaft and wherein the other crank is positioned at the opposite outer end of the shaft and wherein part of the rotating shaft is the rotor of the electric motor.

Applicants found that by positioning cranks at the outer ends of the shaft and by directly driving the shaft as claimed, a shaft can be used which requires much less torsional rigidity. This may be explained as follows. For a given required stiffness against rotational loads working on the moveable support a certain torsional rigidity of the rotating shaft is required. This required torsional rigidity is proportional to the square of the crank radius. The crank of the movement simulator according to the invention may have the same dimensions as the excenter of the electrical motor of the prior art platform described in WO2013/050626 and thus significantly smaller than the driving crank of the prior art platform described in WO2013/050626. Thus, a significantly lower torsional rigidity of the shaft is required for the simulator according to the invention. Furthermore, the movement simulator according to the invention has fewer moving parts because it does not have a mechanical coupling involving a push pull rod connecting an excenter on the motor shaft to a driving crank fixed onto the shaft as in WO2013/050626. This is advantageous in terms of wear, maintenance and dynamic performance. The shaft itself can make full rotations in case of a failure in its control system, and not result in damage of the system. Further advantages will be described when discussing the embodiments below.

The movement simulator has three actuators. The purpose of the actuator is twofold. One is to lock rotational degrees of freedom of the moveable support. The other is to drive the moveable support in the three translational directions. The movement simulator according to the invention allows the use of a crank radius adapted to the required translational movement of the moveable support. Thus, avoiding the concept specific large crank radius as in the prior art movement platform.

Each actuator is connected to a base via its support structure. A base may be another moveable platform, such as for example of a 6 degrees of freedom movement simulators, or a static base, such as the floor of a building.

The support structure is preferably provided with means to connect the support structure to the base. Such means may be provisions for bolts and the like.

The support structure may be comprised in one housing in which at least two bearings are present. The electric motor will then be located axially next to the support structure, wherein one end of the shaft extends from the electric motor and one end extends directly from the support structure.

Preferably the support structure comprises two spaced apart supports positioned close to the ends of the shaft. For such spaced apart supports it is preferred that the electric motor is positioned between the two supports. The stator of the electric motor may be connected to one of the two spaced apart supports. Each support of such separated supports will comprise of at least one bearing for the rotating shaft. The bearing is preferably a single or double pre-loaded bearing.

The electric motor may be any motor comprising of a rotor and a stator which generates a torque between stator and rotor by applying electrical power. The rotor may be provided with conductors in which an electrical current is generated by inductance which in turn interacts with a magnetic field generated by the stator. Preferably the rotor is provided with magnets which may be permanent magnets or electromagnets. Examples of a suitable electric motor are the permanent magnet brushless DC motor (PMBDC), the switched reluctance motor (SRM), the synchronous motor and the inductance motor. A preferred electric motor configuration is a hollow shaft motor. Such a motor can be easily fitted on the shaft and especially on a part of the shaft between two supports. The rotating part of the hollow shaft motor may be fixed to the exterior of the shaft before the shaft is fitted into the support or supports. In an alternative design permanent magnets may be mounted directly on the shaft.

These three translational degrees of freedom are accommodated by a combination of the links and the joints on each end of the links. In some embodiments, the joints on each end of each link are at least 2 degree of freedom joints. In some embodiments, the joint on one end of each link is a 1 degree of freedom joint. In such embodiments, each link may include a push pull rod and a flex plate that connects to the 1 degree of freedom joint. In such embodiments, the flex plate of the link allows the link to bend to accommodate the moveable support motion in the direction of the rotational axis of the shaft, without the need for a multiple degree of freedom connection to the crank. Three degree of freedom joints are also possible. Examples of multiple degree of freedom joints are 3DOF ball joints, such as rod-end ball joints, and universal joints. Possible combinations are presented in the below table.

| | Connection | Connection to |
|---|---|---|
| Link | to crank | moveable support |
| Push pull rods | 3 DOF ball joints | 3 DOF ball joints |
| Push pull rods | 3 DOF ball joints | Universal joints |
| Push pull rods | Universal joints | Universal joints |
| Push pull rods | Universal joints | 3 DOF ball joints |
| Push pull rods + flex plates | 1DOF joints | 2 DOF joints |

The crank as present at the ends of the shaft may be any configuration which results in that axis of rotation Z of the joint center of the joint connecting the link to the crank is radially spaced apart by a distance (Y) from the axis of rotation X of the shaft itself. By being radially spaced apart a more or less linear movement of the connected link will result when the shaft oscillates around its axis of rotation X. Such a crank may be an excenter. The crank radius of an excenter suitably falls within the diameter of the adjacent part of the shaft. The excenter may be manufactured by machining the ends of the shaft. The excenter may also be a separate part, connected to the end of the shaft by means of bolts. The crank radius may optionally have a larger radius than the shaft radius, for example if more translational movement is required. Such a crank may suitably be a bolted-on crank.

The movement simulator may be used as a fatigue testing platform to test products or parts of products, as for example automobile parts and subsystems. Cranks having a radial distance of up to 100 mm may then be used, preferably between 20 mm and 100 mm. The movement simulator may also suitably be used as a shaker in a helicopter movement simulator. In such an application high frequency vibrations are required and the radial distance Y is preferably between 5 mm and 20 mm.

The shaker in a helicopter movement simulator application may suitably be positioned on top of a base movement simulator, for example a hexapod or octopod, and below a helicopter cockpit. Hexapods are well known. An example of an octopod is described in applicants WO2017/202920. Alternatively, the shaker according to this invention and helicopter cockpit may be directly connected to a floor of a building. The shaker will simulate the high frequency vibrations a helicopter pilot experiences in real flight optionally in combination with the G-forces generated by the hexapod or octopod.

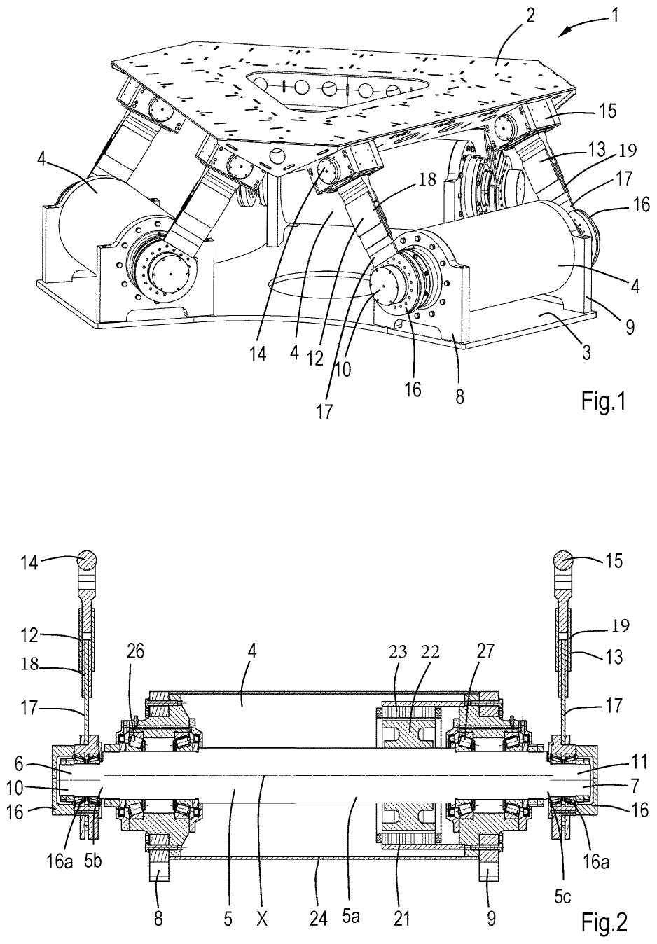

The invention will be illustrated using FIGS. 1-8.

FIG. 1 shows a movement simulator (1) according to the invention and FIG. 2 shows a cross-sectional view along the axis of rotation X of the shaft (5) of one of the actuators (4) of the movement simulator (1) of FIG. 1. The simulator (1) is provided with a moveable support (2) connected to a base (3) by means of three identical actuators (4). Each actuator (4) has a rotating shaft (5) having two outer ends (6,7). Two spaced apart supports (8,9) are shown at the end (6,7) of shaft (5). The support structures (8,9) are provided with double pre-loaded bearings (26,27) supporting the rotating shaft (5). At the two outer ends (6,7) of the shaft (5) a crank having the shape of an excenter (10,11) are present. Excenter (10) is aligned with excenter (11) having the same radius and angle with the shaft (5). Excenter (10) is connected to one link (12) and the other excenter (11) is connected to the other link (13). The links (12,13) are comprised of push pull rods (18, 19) and flex plates (17). The parallel oriented push pull rods (18, 19) of the links (12,13) are connected to the moveable support (2) by an universal joint (14,15). The flex plates (17) of the links (12,13) are connected to the excenter (10,11) by a 1DOF joint (16), using two preloaded bearings (16a). A part (5a) of the shaft (5) is shown between the two supports (8,9) and two parts (5b,5c) of the shaft (5) including the two ends (6,7) of the shaft (5) extend axially outwardly from the supports (8,9). In this Figure an electrical motor (21) is provided with a hollow shaft rotor (21). The rotor (22) of this motor (21) is fixed to part (5a) of the shaft (5) such that it rotates around axis (x) of rotation with the shaft (5). In this way the shaft (5) or at least a part of the shaft is in effect the rotor (22) of the electric motor (21). The stator (23) is connected to support (8). A non-load-bearing tube (24) added between both supports (8,9) covers the motor (21) and optional sensors.

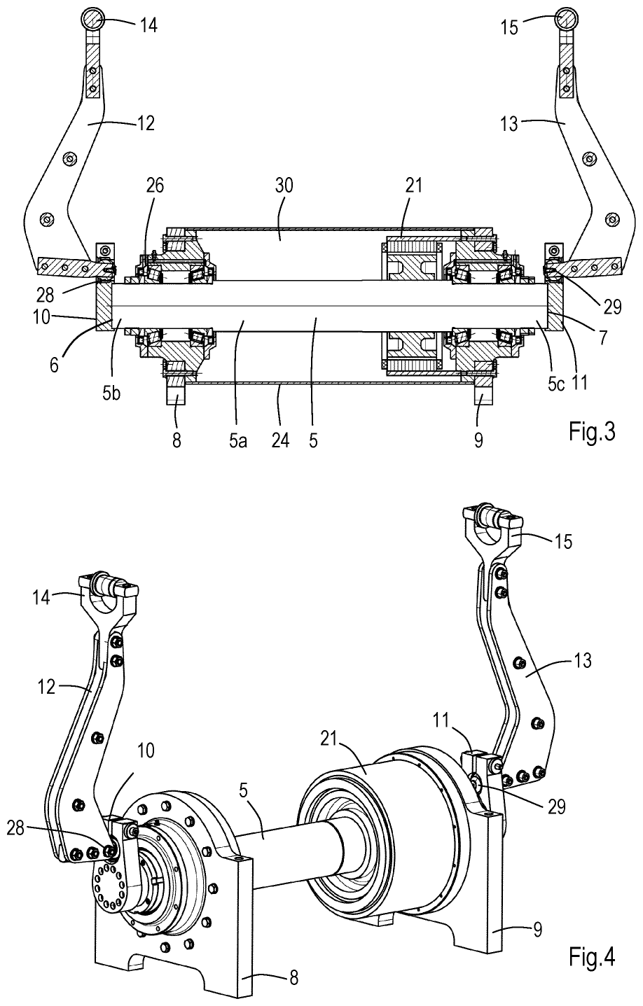

FIG. 3 shows an alternative actuator (30) for the actuator (1) of FIGS. 1 and 2. The difference is that a bolted on crank (10) is connected to one link (12) by means of a ball joint (28) and a bolted on crank (11) is connected to the other link (13) by means of a ball joint (29). Such a configuration is referred to as an inverted ball joint. The links (12,13) are connected to the moveable support (2) by an universal joint (14,15). The ball of the ball joint is part of the link. The ball is received in a spherical liner which is part of the crank. The link (12,13) is provided with a curve such that a sufficient clearance is achieved between the link (12,13) and the crank (10,11). The advantage of such a design is that, in case the shaft is making full rotations, the moveable support (2) consequently makes large translations in its three degrees of freedom and the link can be shaped to prevent collisions within the systems full envelope of movement. Another advantage is that the axial distance between the shaft bearings (27) and the ball joint (29), and hence the bending loads in the shaft (5) are minimized

FIG. 4 is a three-dimensional view of the actuator (30) of FIG. 3 except that the tube (24) between the supports is not shown.

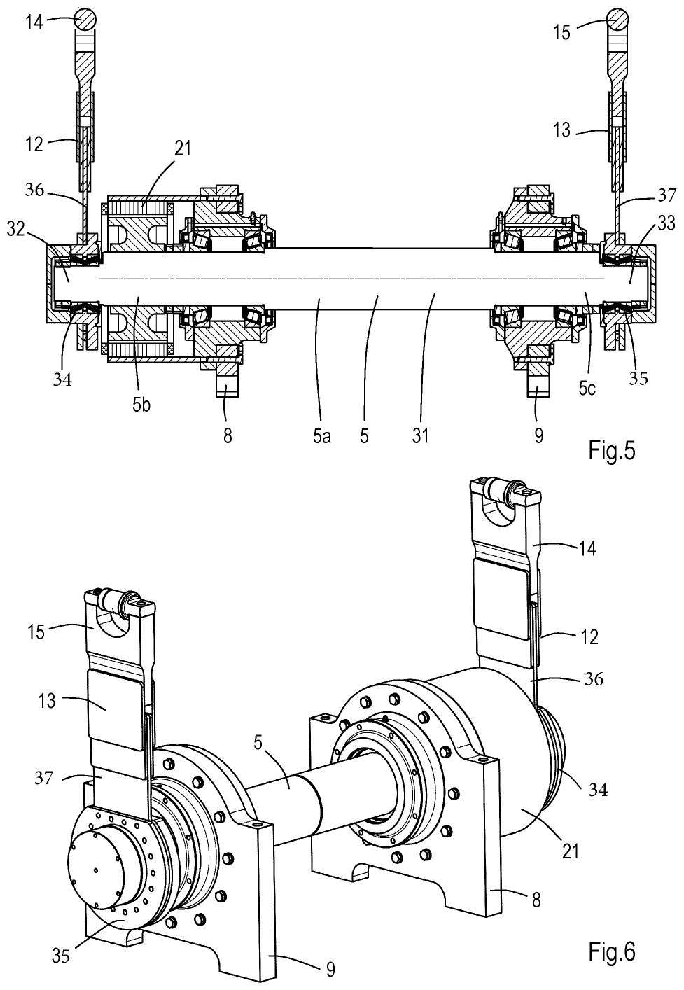

FIG. 5 shows an alternative actuator for the actuator (1) of FIGS. 1 and 2. A difference is that the electrical motor (21) is not positioned between the supports (8,9) as in FIG. 2 but in part (5b) of the shaft (5) as shown. In this figure also an excenter (32,33) is shown which is a machined end of the shaft (5). The flex plates (36, 37) of the links (12,13) are connected to these excenters (32,33) by means of a 1 degree of freedom joint (34, 35). The 1 degree of freedom joints (34, 35) are provided with bearings to provide the rotational degree of freedom relative to the excenters (32,33). An advantage of positioning the electric motor (21) at the exterior end of the shaft (5) is that the electrical motor can then be simply removed to be, for example, replaced of repaired without having to remove the shaft (5) from its supports (8,9).

FIG. 6 is a three dimensional view the actuator of FIG. 5.

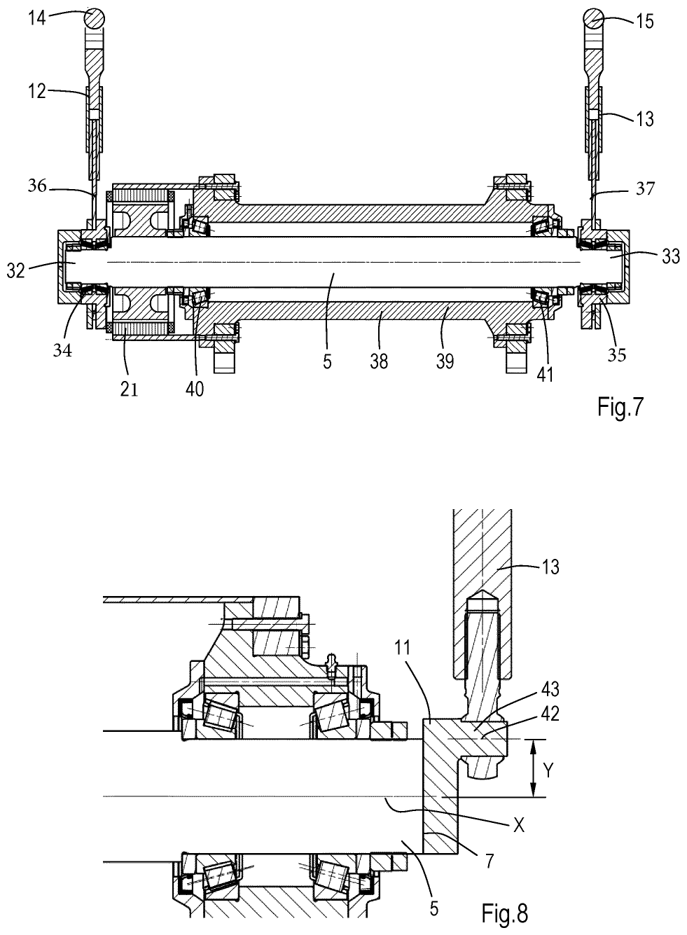

FIG. 7 shows an alternative actuator for the actuator (31) as shown in FIGS. 5 and 6. The actuator is provided with a support structure (38) as comprised in one housing (39) in which two bearings (40,41) are present to support the shaft (5).

FIG. 8 shows a detail of an end (7) of a shaft (5) provided with a bolted-on crank (11). This figure illustrates the crank radius as radial distance (y) between the axis of rotation (x) of the shaft (5) and the joint centre (42) of the joint (43) connecting the crank (11) and the link (13).

It has been found that the use of a flex plate as described above may also be advantageous in movement simulator comprising of a moveable support and having three translational degrees of freedom provided with any type of actuator. This because the use of a flex plate simplifies the design by eliminating the use of a multiple degree of freedom connection to the crank. For this reason the invention is also directed to a movement simulator comprising of a moveable support having three translational degrees of freedom connected to a base by means of three torque devises comprising a rotating shaft having an excenter at its two outer end, a support structure comprising bearings for the rotating shaft, which support structure is connected to the base, and a pair of parallel oriented links connecting the excenters of the shaft to the moveable support and wherein the links are comprised of push pull rods and flex plates, wherein the push pull rods of the links are connected to the moveable support by means of an universal joint, a spherical joint or another flex plate or flex plates and wherein the flex plates are connected to the excenter by a 1DOF joint and wherein the movement simulator is provided with three actuators.

The torque devices may be as shown in FIGS. 1, 2, 5, 6, 7 and 8. Instead of the preferred electromotor (21) shown in these figures as the actuator another actuator may alternatively be used as described below. The three actuators may directly move the moveable support, for example by means of three linear actuators connected to the base and the moveable support as for example shown in Youtube video titled DTE 3-DOF Vibration System Running a Simulated Earthquake Test (https://www.youtube.com/watch?v=vLDGccz1PgU&t=2s). The actuators may also drive the shaft of the torque device as described in the aforementioned WO2013/050626 or as shown in Youtube video titled “Kollmorgen Cartridge DDR Motor used in Earthquake simulator built by ANCO Engineers” or according to the present invention.

The actuator may be an electric motor connected to the shaft of the torque device via a push pull rod. The electric motor is connected to the base. The push pull rod is connected at one end to an excenter or crank on the rotating shaft of the electric motor and at its other end to a driving crank positioned between the two excenters of the rotating shaft. The oscillating rotation of the rotor of the electric motor will result in an oscillating movement of the shaft and thus achieve the movement of the moveable platform in the three translational directions. Such an actuator is described in WO2013/050626.

The actuator may also be an electric motor connected to the shaft of the torque device via a push pull rod. The electric motor is connected to the base. The push pull rod is connected at one end to an excenter or crank on the rotating shaft of the electric motor and at its other end to the moveable support via a joint as described above. The oscillating rotation of the rotor of the electric motor will result in an oscillating movement of the platform in the three translational directions. The three rotating actuators directly move the moveable support.

1. A movement simulator comprising of a moveable support having three translational degrees of freedom connected to a base by means of three actuators, wherein each actuator comprises a rotating shaft having two outer ends and comprising two spaced apart cranks, an electric motor comprising a rotor and a stator, a support structure comprising bearings for the rotating shaft, which support structure is connected to the base, and a pair of links connecting the cranks of shaft to the moveable support,
wherein one crank is positioned at one outer end of the shaft and wherein the other crank is positioned at the opposite outer end of the shaft and wherein part of the rotating shaft is the rotor of the electric motor.

2. A movement simulator according to claim 1, wherein the support arrangement comprises two spaced apart supports defining a part of the shaft between the two supports and two parts the shaft including the two ends of the shaft extending axially outwardly from the supports.

3. A movement simulator according to claim 2, wherein the part of the rotating shaft which is the rotor of the electric motor is positioned between the supports.

4. A movement simulator according to claim 3, wherein the stator of the electric motor is connected to one or both of the two spaced apart supports.

5. A movement simulator according to claim 1, wherein the two links are connected to the cranks by means of at least 2 degree of freedom joints.

6. A movement simulator according to claim 1, wherein the crank is an excenter.

7. A movement simulator according to claim 5, wherein the two links are connected to the cranks by means of an inverted ball joint.

8. A movement simulator according to claim 1, wherein each link comprises a push pull rod and a flex plate, and the flex plates of the links are connected to the cranks by means of preloaded bearings.

9. A movement simulator according to claim 1, wherein the radial distance (y) between the axis of rotation (x) of the shaft and the joint center of the joint connecting the crank and the link is between 5 and 20 mm.

10. Use of a movement simulator according to claim 9 as a shaker as part of a helicopter movement simulator.

11. A movement simulator comprising of a moveable support having three translational degrees of freedom connected to a base by means of three torque devises comprising a rotating shaft having an excenter at its two outer end, a support structure comprising bearings for the rotating shaft, which support structure is connected to the base, and a pair of parallel oriented links connecting the excenters of the shaft to the moveable support and wherein the links are comprised of push pull rods and flex plates, wherein the push pull rods of the links are connected to the moveable support by means of an universal joint and wherein the flex plates are connected to the excenter by a 1DOF joint and wherein the movement simulator is provided with at least three actuators.

12. A movement simulator according to claim 11, wherein the actuator is an electric motor connected via a push pull rod to a driving crank positioned on the shaft of the torque device and wherein the driving crank is positioned between the two excenters of the rotating shaft and wherein the other end of the push pull rod is connected to an excenter on the rotating shaft of the electric motor.

13. A movement simulator according to claim 11, wherein the actuator is an electric motor provided with a rotating shaft and directly connected to the moveable platform by means of a push pull rod, wherein the push pull rod is connected at one end to an excenter or crank on the rotating shaft and at its other end to the moveable support via a joint.
